(19) United States
(12) Patent Application Publication
(10) Pub. No.: US 2024/0174311 A1
(43) Pub. Date: May 30, 2024

(54) MOTORCYCLE KICKSTAND ACCESSORY

(71) Applicant: Robert RICCIARDI, Islip, NY (US)

(72) Inventor: Robert RICCIARDI, Islip, NY (US)

(21) Appl. No.: 18/071,236

(22) Filed: Nov. 29, 2022

(51) Int. Cl. B62H 1/06; B62J 6/01

(52) U.S. Cl. CPC B62H 1/06; B62J 6/01

(57) ABSTRACT

The present disclosure refers to a motorcycle accessory for improving the weight-distribution of a motorcycle on its kickstand. The accessory is a plate that can be moved out of its housing attached to the motorcycle to the ground where the user wants to place the kickstand. The housing is attached to motorcycle by a mounting element. The plate can include an LED light, various attachments, and various surfaces designed to keep the plate in place.

### CROSS-REFERENCE TO RELATED APPLICATIONS

This application relates to U.S. patent application Ser. No. 334,573, filed Nov. 7, 1994 (now U.S. Pat. No. 5,484,153), the contents of which are incorporated herein in its entirety.

### FIELD OF THE DISCLOSURE

The present disclosure relates to improvements for a weight-bearing plate for a motorcycle kickstand of a type used to mitigate surface marring of soft terrain or the like by the kickstand leg under the typically heavy weight of the motorcycle.

### BACKGROUND

Motorcycles often have kickstands or legs that are used to sit the motorcycle upright while the motorcycle is not in use. Conventionally, these kickstands are somewhat narrow. Because the kickstand is bearing the load of motorcycle, it can apply a very large amount of pressure to the surface on which the motorcycle is parked. For example, the kickstand may be standing the motorcycle on pavement, asphalt, or some other surface. Such surfaces can become marred by the weight of the motorcycle focused on the kickstand.

Thus, there is a need for a device that alleviates the pressure applied on the kickstand and prevents marring of surfaces by the kickstand.

### SUMMARY OF THE DISCLOSURE

Aspects of the disclosed embodiments include a kickstand accessory configured to alleviate pressure applied by the kickstand and attach to the motorcycle. In one exemplary embodiment, the kickstand accessory can include a plate having an operative position interposed between a kickstand leg and a surface, wherein an underside of the plate is configured to have a slip-mitigating surface; a housing attachable to the motorcycle, wherein the housing is configured to store the plate, a spring having an inner end fixed against movement and presenting an unfixed outer end, a chain configured to connect the plate and the outer end of the spring such that the plate can be manually removed against spring urgency and the plate can return to the housing under the spring urgency, wherein the operative position of the plate holds the plate; and a mounting element configured to attach the housing to the motorcycle.

In one example embodiment, the housing in a non-operative position holds the plate such that the spring urgency prevents any rattling of the chain against the motorcycle. In one example embodiment, the mounting element is non-removably attached to the motorcycle via a pipe on the motorcycle. In one example embodiment, the mounting element is removably attached to the motorcycle via a pipe on the motorcycle. In one example embodiment, the plate further includes a flange on an extremity facing away from the spring. In one example embodiment, the flange further includes a ring element secured to the flange. In one example embodiment, the plate is removably attached to the chain such that the plate can be replaced by a different plate. In one example embodiment, the slip-mitigating surface consists of at least one selected from the group of a spiked surface, an abrasive surface, and a ridged surface.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram illustrating a motorcycle with a kickstand accessory according to an exemplary embodiment.

FIG. 2A is an exemplary diagram illustrating exemplary kickstand accessory unattached to a motorcycle rod according to an exemplary embodiment.

FIGS. 2B-2D are exemplary diagrams illustrating exemplary kickstand accessories unattached to a motorcycle rod according to exemplary embodiments.

FIG. 3A is a diagram illustrating the kickstand accessory attached to the motorcycle rod according to an exemplary embodiment.

FIG. 3B is shows an exemplary device for communicating with the kickstand accessory according to an exemplary embodiment.

FIG. 4 is a diagram illustrating a cross-sectional view of the unattached kickstand accessory according to an exemplary embodiment.

FIG. 5 is a diagram illustrating the use of the kickstand accessory according to an exemplary embodiment.

FIGS. 6A-6C illustrate a kickstand accessory with an element for avoiding slippage on the bottom of the plate.

FIG. 7 is a diagram illustrating the plate with a heat-sensitive element.

FIGS. 8A-8C are diagrams illustrating plates of a kickstand accessory with various optional elements.

FIG. 9 shows an exemplary embodiment of the kickstand accessory which includes more than one plate.

FIG. 10 illustrates exemplary hardware components of an exemplary computing circuitry according to an exemplary embodiment.

### DETAILED DESCRIPTION

Exemplary embodiments will now be described in order to illustrate their various features. The embodiments described herein are not intended to be limiting as to the scope of the disclosure, but rather are intended to provide examples of the components, use, and operation of these embodiments. Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

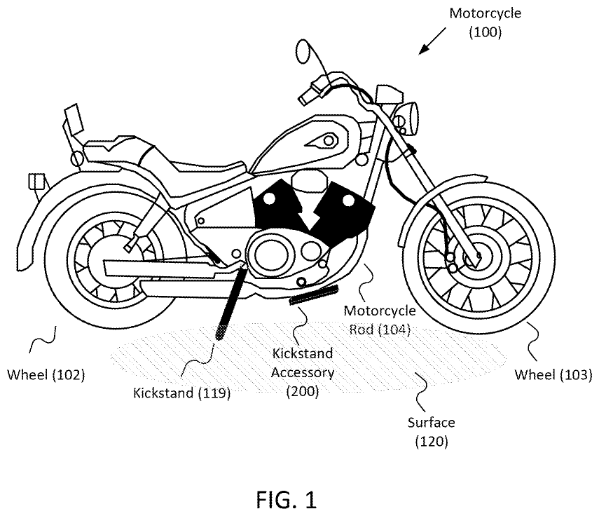

FIG. 1 is a diagram illustrating a motorcycle 100 having the kickstand accessory 200 according to an exemplary embodiment. The present embodiments can be used generally with a motorcycle 100 in FIG. 1. The motorcycle 100 can have front and rear wheels 102 and 103, a motorcycle rod 104, a kickstand 119, and a kickstand accessory 200. The kickstand 119 can be positioned in between the wheels 102 and 103. The kickstand 119 can cooperate with wheels 102 and 103 to define a tripod support during non-use of the motorcycle 100, e.g., when the motorcycle 100 is parked on a macadam or other support surface 120 of a restaurant customer parking lot or the like. In one example, the motorcycle rod 104 can be an exhaust pipe of the motorcycle or a part of the frame of the motorcycle.

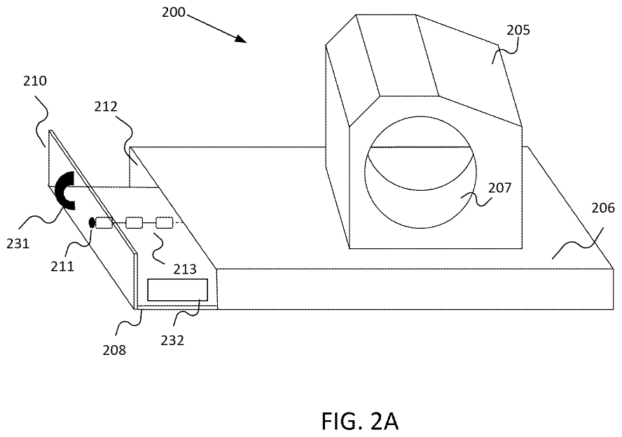

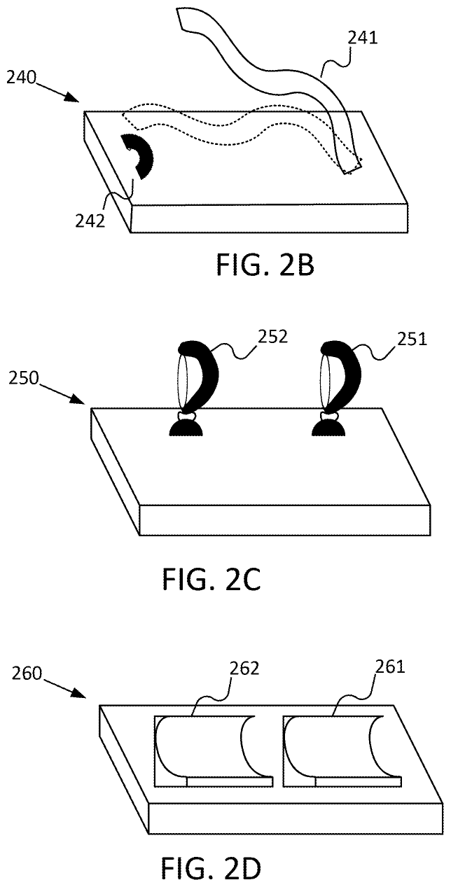

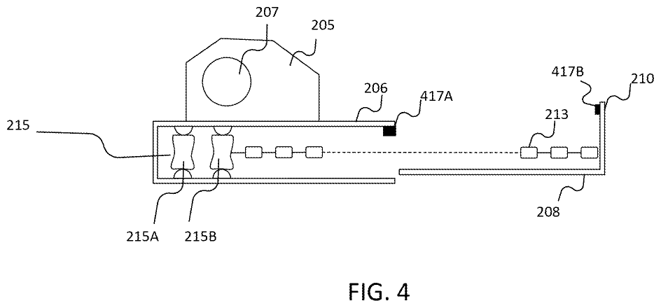

FIG. 2A is a diagram illustrating the kickstand accessory 200 unattached to the motorcycle rod 104 according to an exemplary embodiment. One example embodiment of the kickstand accessory 200 includes a housing 206 including a storage area 212 for a plate 208. The storage area 212 can also store a chain 213, a spring system 215 (e.g., including one or more springs 215A and 215B) (FIG. 4), and one or more securing elements 417A and 417B (FIG. 4). In one example, a user can remove the plate 208 from the storage area 212. The plate 208 remains connected to the housing 206 using the chain 213, which can retract the plate 208 using the spring system 215. In one example, the plate 208 can be connected to a flange 210. In one example, the flange 210 can be connected to the chain 213 using a connector 211. When the plate 208 is retracted using the spring system 215, the flange 210 can stop the plate 208 from moving too much inside the storage area 212. In one example, the flange 210 can be larger than the opening for the storage area 212. In this example, the user can grab the flange 210 and remove the plate 208 from the storage area 212. In one example, the flange 210 can include one or more optional handles 231. The user can pull the plate 208 out of the storage area 212 using the handle 231. In one example, the flange 210 can be smaller than the opening for the storage area 212, and therefore, when the plate 208 is fully retracted, the flange 210 can go inside the storage area 212.

In one example, the spring system 215 can be a retractable spring system, e.g., the spring system 215 can generate a tension when the chain 213 is pulled. In one example, the spring system 215 can be locked once the chain 213 is reached a predetermined length, e.g., 2 or 3 feet. The spring system 215 can continue to retract the chain 213, if the chain 213 is pulled after it reaches the predetermined length.

In one example, springs 215A and 215B will be understood to be negator springs (or a negator spring system) of the type illustrated and described in U.S. Pat. No. 5,261,882 (issued on Nov. 16, 1993), the description of which is incorporated herein by reference. In one example, the negator springs have an inner end 215A fixed against movement and an outer end 215B that is urged by a pulling force through windup movement against the resistance of the helical configuration of the negator spring. Upon release of the pulling force, the helical configuration restores itself and produces a constant force or spring urgency which, in turn, produces a helical wrap of the chain 213 in encircling relation about the spring 215A or 215B. The chain 213 is connected at its opposite ends, spanning relation respectively between the spring end 215A or 215B and the flange 210 of the plate 208. The flange 210 can also serves as a stop limiting the return movement of plate 208 into its storage area 212 or non-use condition which contributes to maintaining the stored chain 213 under the urgency of the springs 215A and 215B.

In one example, in addition to or instead of the spring system 215, a magnetic system can be implemented to attach the plate 208 to the housing 206. For example, one or more magnets 417A and 417B may be placed on the plate 208, the flange 210 or the housing 206, and these magnets can generate a magnetic force sufficient to attach the plate 208 (and/or flange 210) to the housing 206. These magnets can create a tension when the user desires to remove the plate 208.

In one example, the kickstand accessory 200 can include a mounting element 205. The mounting element 205 can be secured by, e.g., a nut and a bolt, to the housing 206. The mounting element 205 can attach the kickstand accessory 200 to, e.g., the motorcycle rod 104 in the vicinity of the kickstand 119. The mounting element 205 can be secured to the motorcycle rod 104 by a hole 207 configured to fit the motorcycle rod 104. In one example, the mounting element 205 can utilize magnetic force to attach the housing 206 to the motorcycle rod 104. For example, the mounting element 205 can be a magnet configured to attach to the motorcycle rod 104. As another example, the hole 207 can be replaced with a pair of elements, e.g., hook and loop, to detachably secure the housing 206 to the motorcycle rod 104.

FIG. 2B-2D are exemplary embodiments of the mounting element for securing the kickstand accessory to the motorcycle rod. In FIG. 2B, accessory 240 illustrates a mounting element 241 that is a piece of pliable fabric such as a strap, belt, or some fabric that can be tied to a securing element 242. The securing element 242 can be a loop securely attached to the motorcycle accessory 240. The mounting element 241 can be configured to wrap around the motorcycle rod 104 and tie back onto the securing element 242. In other embodiments, the mounting element 241 can further comprise at the free end a hook, buckle, snap, magnet, or hook, each of which can be configured to mate with the securing element 242. In FIG. 2C, accessory 250 illustrates a pair of mounting elements 252 and 251 which are snap hooks configured to connect temporarily to the motorcycle rod 250. In FIG. 2D, kickstand accessory 260 illustrates a pair of mounting elements 261 and 262 which are magnets securely attached to the housing of the accessory 260. The magnets are configured to mate with the motorcycle rod 240. It is understood that for all embodiments referenced, there can be more or fewer mounting elements than depicted. In one example, the mounting element 241 can be a metal strap.

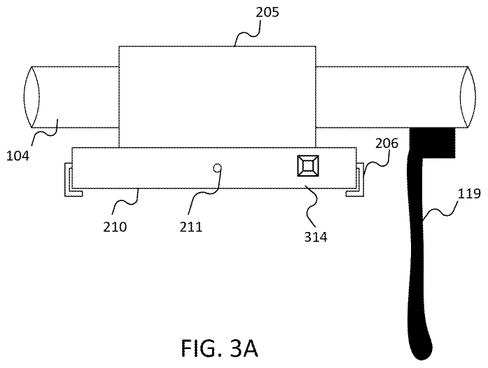

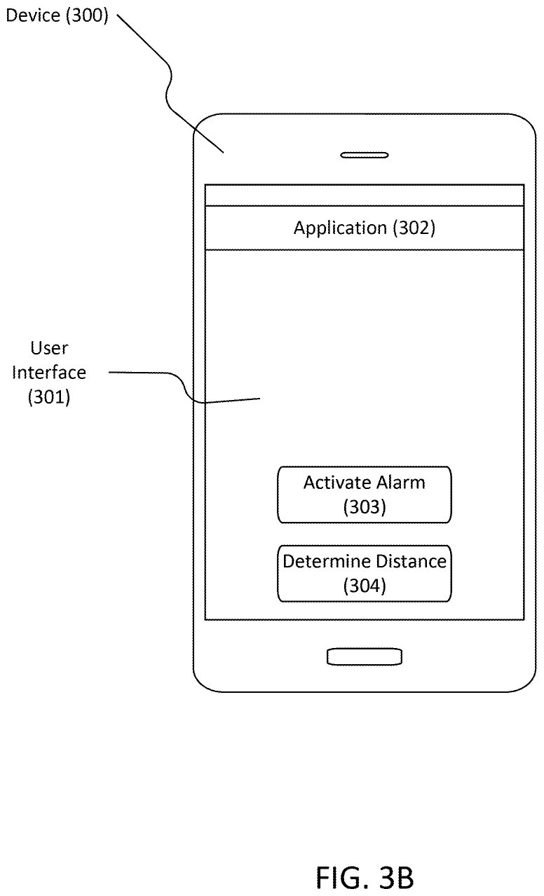

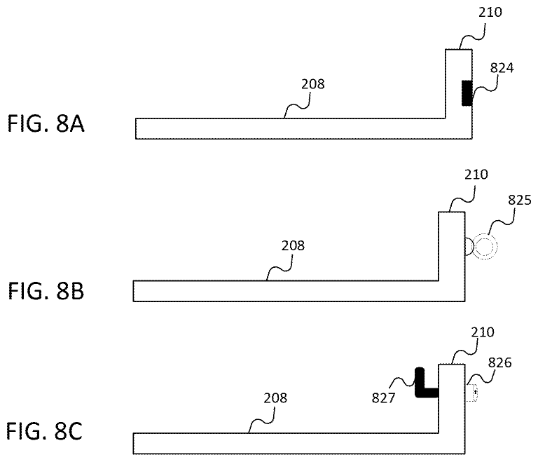

FIG. 3A is a diagram illustrating the kickstand accessory 200 attached to the motorcycle rod 104 according to an exemplary embodiment. The kickstand accessory 200 can be removably attached to the motorcycle rod 104 via the mounting element 205 (e.g., using a mechanical force, a magnetic force, adhesives such as glue, or even a Velcro tape). The kickstand accessory 200 can be mounted such that the kickstand accessory 200 is closely locate to the kickstand 119. In one example, the kickstand accessory 200 can be configured such that the flange 210 of the plate 208 is facing towards the kickstand 119. The plate 208 can be pulled out from the housing 206 by one or more pulling mechanisms discussed with further reference to FIGS. 8A-8C. In some embodiments, the flange 210 can include a light 314, which can be activated, e.g., upon receiving a signal from a cellphone or upon detecting that the user is within a vicinity of the light 314. In some embodiments, the light 314 can be activated when a switch of the light 314 is turned on. The light 314 can assist the user in dark spaces or at night time to easily locate the light 314 as well as the motorcycle 100 (or a bicycle or scooter if the kickstand accessory 200 is attached to the bicycle or scooter). The light 314 can include without limitation LED lights. In one example, in addition to or instead of the light 314, the plate 208 can include a sound generator or other devices to alert the user. The sound generator can be activated similar to the light 314.

To power the light 314, the kickstand accessory 200 can include a battery. In one example, the housing 206 or the plate 208 can include a computing circuitry 232 (FIG. 2) including a memory, a processor, a transceiver, and a battery. The computing circuitry 232 can process, send and receive signals from other devices. In one example, the computing circuitry 232 can receive GPS signals and determine a location for the computing circuitry 232. In one example, the computing circuitry 232 can be paired with an application (e.g., an application that runs on a cellphone, smart watch, tablet, laptop, etc.). The computing circuitry 232 can communicate with the application and receive instructions or provide instructions to the application. For example, the application can instruct the computing circuitry 232 to turn on the light 314 or generate an alarm using the sound generator. In one example, the computing circuitry 232 can send a signal to the application, which can in turn indicate a distance from the computing circuitry 232 (either the computing circuitry 232 or the application can determine the distance).

FIG. 3B is shows an exemplary device 300 for communicating with the kickstand accessory 200 according to an exemplary embodiment. In this example embodiment, the user can use the device 300 for transmitting commands to the kickstand accessory 200 and the computing circuitry 232. The device can display a user interface 301, which can display the application 302. In one example, the application 302 can display two buttons, an activate alarm 303 and a determine distance 304. In an example embodiment, a user can press the activate alarm 303 icon. In response the device 300 can send a signal to the computing circuitry 232. Upon receiving the signal, the computing circuitry 232 can activate the light 314 to, e.g., flash according to a predetermined pattern.

In an example embodiment, a user can press the determine distance 304 icon. In response the device 300 can send a signal to the computing circuitry 232. Upon receiving the signal, the computing circuitry 232 can send the GPS coordinates of the kickstand accessory 200 to the device 300. The device 300 can determine its distance from the computing circuitry 232 based on the GPS coordinates. In another example, the device 300 or the computing circuitry 232 can determine the distance using a signal that is transmitted by the computing circuitry 232 or the device 300, e.g., using triangulation technique.

FIG. 4 is a diagram illustrating a cross-sectional view of the kickstand accessory 200 according to an exemplary embodiment. The plate 208 can be pulled from the housing 206, thereby unwinding the chain 213 which has a constant urgency created by the springs 215A and 215B. To further secure the plate 208 to the housing 206, the kickstand accessory 200 can include one more securing elements 417A and 417B. In some embodiments, the securing elements 417A and 417B can include two magnets configured to mate with one another. In other embodiments, the securing elements 417A and 417B can include button and buttonhole assemblies or key and lock assemblies. In one example, securing elements 417A and 417B may either or both be attached to the housing 206, plate 208, flange 210, and/or mounting element 205. Securing elements 417A and 417B, in some embodiments, may be removable from the kickstand accessory 200. Some embodiments may have only one securing element while others can have two or more.

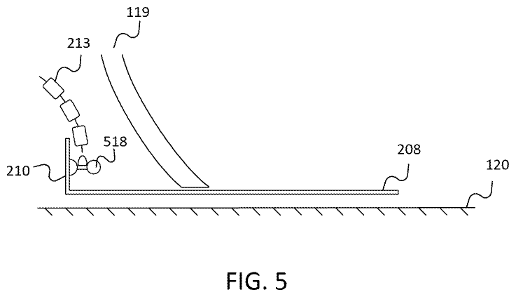

FIG. 5 is a diagram illustrating the use of the kickstand accessory 200 according to an exemplary embodiment. Surface marring is obviated according to the present disclosure using the plate 208. In one example, the plate 208 can be constructed using metal material (or metal alloy) to support the motorcycle weight while retaining its flat configuration. In some embodiments, the plate 208 can be interposed between the free end of the kickstand 119 and the surface 120. The kickstand accessory 200 can protect surface 120 against defacement. The chain 213 can be attached to the flange 210 via a chain attachment 518.

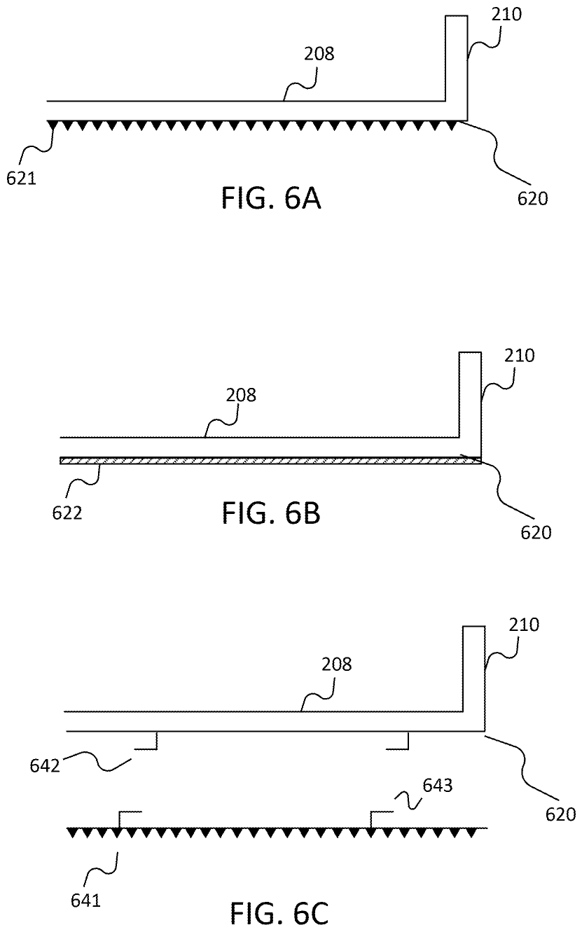

FIGS. 6A-6C are diagrams illustrating different configurations for the underside 620 of the plate 208. In some examples, the surface 120 upon which the plate 208 can be placed is slippery, uneven, soft, delicate, or otherwise imperfect. Thus, it will be beneficial to include plates 208 that have undersides 620 which are capable of protecting the kickstand 119 from slipping. FIG. 6A illustrates a plate 208 with one or more spikes 621 on the underside 620. This configuration is especially helpful in grassy or ground surface areas. FIG. 6B illustrates a plate 208 with an abrasive material 622 on the underside.

FIG. 6C shows an example plate 208 which can receive an interchangeable underside. In this example, the plate 208 can include one or more mechanisms 642 for holding an underside surface 641, e.g., a hook 642. The underside surface 641 can also include one or more mechanisms 643 for pairing with the mechanism 642 to hold the underside surface 641 against the plate 208. The mechanism 643 can be a loop or another hook. In this example, the user can attach various underside surfaces 641 to the plate 208 depending on the nature of the use needed for the kickstand accessory 200. For example, an underside surface 641 can include spikes; another underside surface can include abrasive material; yet another underside surface can be larger than the plate 208, e.g., in circumstances when the motorcycle is being parked in mud; yet another underside surface can include lights for flashing. For example, the underside can be electronically coupled to the computing circuitry 232, and the computing circuitry 232 can provide signals to the underside surface to flash one or more lights according to a predetermined pattern. In one example, an application can detect a tune being played in the background and detect a number of beats per second for the tune. The application can convey the number to the computing circuitry 232 to, e.g., flash the underside surface 641 at the same beats per second rate.

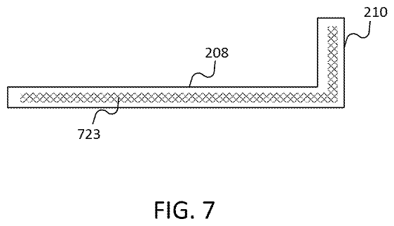

FIG. 7 illustrates a plate 208 with a heat sensitive element 723. The heat sensitive elements can cover part or the whole of the surface of the plate 208 and flange 210. The heat sensitive element 723 can be configured such that when the plate 208 touches a surface that is particularly hot, the heat sensitive element 723 will change color. This change in color signals to the user that the ground, e.g., asphalt, is hot enough to mar the surface with a kickstand bearing the weight of the motorcycle. The heat sensitive element can be configured to perform a visual change. The visual change can include without limitation: a change from a first color to a second color (e.g., from blue to red); from a first pattern to a second pattern; or from no pattern to a first pattern. The heat sensitive element can react to the temperature of the ground on which it is placed. The heat sensitive element can be configured to perform the visual change in reaction to any predetermined temperature. In some embodiments, the heat sensitive element can perform the visual change in reaction to temperatures at or above 100 degrees Fahrenheit.

FIGS. 8A-8C illustrate various embodiments of the plate 208 and the flange 210 according to exemplary embodiments. In these examples, different pulling mechanisms are provided which can help secure the plate 208 to the kickstand accessory 200 as well as assist the user in removing the plate 208 from the housing 206. In FIG. 8A, for example, the flange 210 can include a magnetic element 824 which can operably interact with an independent magnet held by the user. In this embodiment, the flange 210 can be shortened such that flange is contained in the housing 206 when the chain 213 is fully retracted. Thus, in this example, the only way to remove the plate 208 can be by using the magnetic element 824. In FIG. 8B, for example, the flange 210 can include a pull element 825 consisting of a pull ring attached to the external surface of the flange 210. In FIG. 8C, for example, the flange 210 can include a lock 826 and an operable element 827. With a key, the user can engage with the lock 826, and thus, move the operable element 827 to lock or unlock the plate 208 from the housing 206. The operable element 827 may engage with on more housing flanges configured to prevent the removal of the plate 208. In one example, the computing circuitry 232 can be connected to the lock 826, and the application can lock or unlock the lock 826 using a wireless signal. This provides the user with the ability to store valuables in the kickstand accessory 200 and access the space using a keyless mechanism, e.g., through an application.

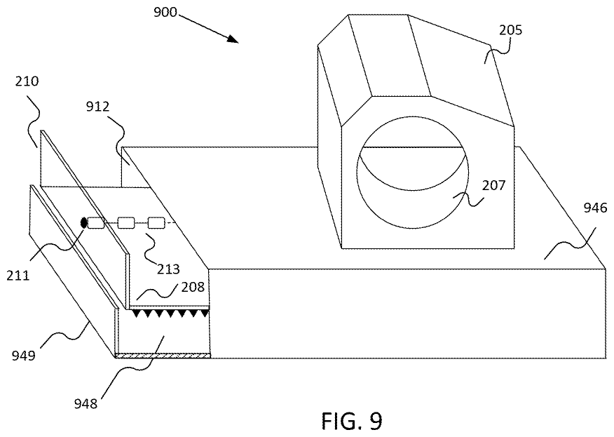

FIG. 9 shows an exemplary embodiment of the kickstand accessory 900 which includes more than one plate. In this example embodiment, the kickstand accessory 900 can include a housing 946, which can fit two plates, namely plate 208 and plate 948, in a storage area 912. In one example, each plate can include a different underside, thereby giving the user the option to switch between the plates depending on the application. In one example, the plate 948 can include similar (or different) components as plate 208. For example, the plate 948 can include a flange 949.

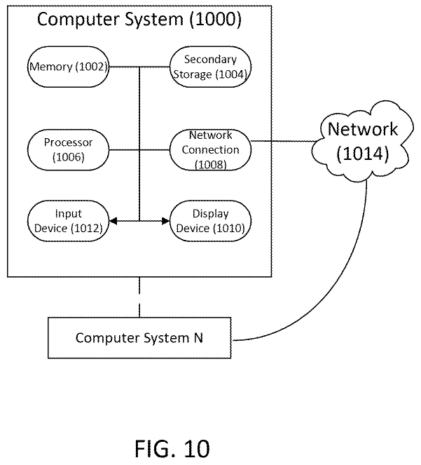

FIG. 10 illustrates exemplary hardware components of an exemplary computing circuitry (or computer system). A computer system 1000, or other computer systems similarly configured, may include and execute one or more subsystem components to perform functions described herein, including the steps of various flow processes described above. Likewise, a mobile device, a cell phone, a smartphone, a laptop, a desktop, a notebook, a tablet, a wearable device, a server, etc., which includes some of the same components of the computer system 1000, may run an application (or software) and perform the steps and functionalities described above. Computer system 1000 may connect to a network 1014, e.g., Internet, or other network, to receive inquiries, obtain data, and transmit information and incentives as described above.

The computer system 1000 typically includes a memory 1002, a secondary storage device 1004, and a processor 1006. The computer system 1000 may also include a plurality of processors 1006 and be configured as a plurality of, e.g., bladed servers, or other known server configurations. The computer system 1000 may also include a network connection device 1008, a display device 1010, and an input device 1012.

The memory 1002 may include RAM or similar types of memory, and it may store one or more applications for execution by processor 1006. Secondary storage device 1004 may include a hard disk drive, floppy disk drive, CD-ROM drive, or other types of non-volatile data storage. Processor 1006 executes the application(s), such as those described herein, which are stored in memory 1002 or secondary storage 1004, or received from the Internet or other network 1014. The processing by processor 1006 may be implemented in software, such as software modules, for execution by computers or other machines. These applications preferably include instructions executable to perform the system and subsystem component functions and methods described above and illustrated in the FIGS. herein. The applications preferably provide graphical user interfaces (GUIs) through which users may view and interact with subsystem components.

The computer system 1000 may store one or more database structures in the secondary storage 1004, for example, for storing and maintaining the information necessary to perform the above-described functions. Alternatively, such information may be in storage devices separate from these components.

Also, as noted, processor 1006 may execute one or more software applications to provide the functions described in this specification, specifically to execute and perform the steps and functions in the process flows described above. Such processes may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the computer system 1000.

The input device 1012 may include any device for entering information into the computer system 1000, such as a touch-screen, keyboard, mouse, cursor-control device, microphone, digital camera, video recorder or camcorder. The input and output device 1012 may be used to enter information into GUIs during performance of the methods described above. The display device 1010 may include any type of device for presenting visual information such as, for example, a computer monitor or flat-screen display (or mobile device screen). The display device 1010 may display the GUIs and/or output from sub-system components (or software).

Examples of the computer system 1000 include dedicated server computers, such as bladed servers, personal computers, laptop computers, notebook computers, palm top computers, network computers, mobile devices, or any processor-controlled device capable of executing a web browser or other type of application for interacting with the system.

Although only one computer system 1000 is shown in detail, system 1000 may use multiple computer systems or servers as necessary or desired to support the users and may also use back-up or redundant servers to prevent network downtime in the event of a failure of a particular server. In addition, although computer system 1000 is depicted with various components, one skilled in the art will appreciate that the system can contain additional or different components. In addition, although aspects of an implementation consistent with the above are described as being stored in a memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer system 1000, to perform a particular method, such as methods described above.

In some aspects, the techniques described herein relate to an accessory for attachment to a motorcycle for alleviating a weight of a motorcycle from bearing down on a kickstand, the accessory including: a plate having an operative position interposed between a kickstand and a surface, wherein an underside of the plate is configured to have a slip-mitigating surface; a housing configured to store the plate, a spring having an inner end fixed against movement and presenting an unfixed outer end, a chain configured to connect the plate and the unfixed outer end of the spring such that the plate can be manually removed against spring urgency and the plate can return to the housing under the spring urgency, wherein the operative position of the plate holds the plate; and a mounting element configured to attach the housing to the motorcycle.

In some aspects, the techniques described herein relate to an accessory, wherein the housing in a non-operative position holds the plate such that the spring urgency prevents any rattling of the chain against the motorcycle.

In some aspects, the techniques described herein relate to an accessory, wherein the mounting element is non-removably attached to the motorcycle via a pipe on the motorcycle.

In some aspects, the techniques described herein relate to an accessory, wherein the mounting element is removably attached to the motorcycle via a rod on the motorcycle.

In some aspects, the techniques described herein relate to an accessory, wherein the plate further includes a flange on an extremity facing away from the spring.

In some aspects, the techniques described herein relate to an accessory, wherein the flange further includes a ring element secured to the flange by an attachment means.

In some aspects, the techniques described herein relate to an accessory, wherein the plate is removably attached to the chain such that the plate can be replaced by a different plate.

In some aspects, the techniques described herein relate to an accessory, wherein the slip-mitigating surface is a spiked surface, an abrasive surface, or a ridged surface.

In some aspects, the techniques described herein relate to an accessory attachable to a motorcycle for alleviating a weight of a motorcycle from bearing down on a kickstand, the accessory including: a plate having an operative position interposed between a leg and a surface; a housing configured to store the plate, a spring having an inner end fixed against movement and presenting an unfixed outer end, a chain configured to connect the plate and the unfixed outer end of the spring such that the plate can be manually removed against spring urgency and the plate can return to the housing under the spring urgency, wherein the operative position of the plate holds the plate; a mounting element configured to attach the housing to the motorcycle; a light; and a power source configured to power the light.

In some aspects, the techniques described herein relate to an accessory, further including a computing circuitry including a processor, a memory and a transceiver, wherein, the computing circuitry is configured to transmit GPS coordinates of the computing circuitry to an application and receive an instruction to turn on the light.

In some aspects, the techniques described herein relate to an accessory, wherein the light is configured to turn on only when the plate is pulling from the housing.

In some aspects, the techniques described herein relate to an accessory, wherein: the housing further includes a first magnetic element; the plate further includes a flange; the flange further includes second magnetic element; and the second magnetic element is configured to mate with the first magnetic element such that the plate is removably secured to the housing.

In some aspects, the techniques described herein relate to an accessory, wherein the plate further includes a flange, wherein the flange includes a pull element.

In some aspects, the techniques described herein relate to an accessory, wherein the plate further includes a flange, wherein the flange includes: a lock configured to engage with a key; and an operable element, wherein the operable element is operably attached to the lock such that an engagement of the lock with the key moves the operable element either into a locked position or an unlocked position.

In some aspects, the techniques described herein relate to an accessory, wherein the housing further includes a lip configured to meet the operable element in the locked position.

In some aspects, the techniques described herein relate to an accessory for a motorcycle for alleviating a weight of a motorcycle from bearing down on a kickstand, the accessory including: a plate having an operative position interposed between a leg and a surface; a housing configured to store the plate, a spring having an inner end fixed against movement and presenting an unfixed outer end, a chain configured to connect the plate and the unfixed outer end of the spring such that the plate can be manually removed against spring urgency and the plate can return to the housing under the spring urgency, wherein the operative position of the plate holds the plate; a mounting element configured to attach the housing to the motorcycle; and a heat sensitive element.

In some aspects, the techniques described herein relate to an accessory, wherein the heat sensitive element covers part or whole of the surface of the plate.

In some aspects, the techniques described herein relate to an accessory, wherein the heat sensitive element is configured to perform a visual change in reaction to a change in temperature.

In some aspects, the techniques described herein relate to an accessory, wherein the visual change is a change from a first color to a second color, a change from a first pattern to a second pattern, or a change from no pattern to a first pattern.

In some aspects, the techniques described herein relate to an accessory, wherein the heat sensitive element is configured to perform the visual change in reaction to a change in temperature from below 100 degrees Fahrenheit to at or above 100 degrees Fahrenheit.

Although embodiments of the present disclosure have been described herein in the context of a particular implementation in a particular environment for a particular purpose, those skilled in the art will recognize that its usefulness is not limited thereto and that the embodiments of the present disclosure can be beneficially implemented in other related environments for similar purposes. The disclosure should therefore not be limited by the above-described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the disclosure as oriented in the figures and is not to be construed as limiting any feature to be a particular orientation, as said orientation may be changed based on the user's perspective of the device.

In this disclosure, various embodiments have been described with references to the accompanying drawings. It may, however, be evident that various modifications and changes may be made thereto, and additional embodiments may be implemented, without departing from the broader scope of the disclosure as set forth in the claims that follow. This disclosure and the drawings are accordingly to be regarded in an illustrative rather than restrictive sense.

This disclosure is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The disclosure is to be limited only by the terms of the appended claims, along with the full scope of equivalents to which such representative claims are entitled.

What is claimed is:

1. An accessory for attachment to a motorcycle for alleviating a weight of a motorcycle from bearing down on a kickstand, the accessory comprising:
a plate having an operative position interposed between a kickstand and a surface, wherein an underside of the plate is configured to have a slip-mitigating surface;
a housing configured to store the plate, a spring having an inner end fixed against movement and presenting an unfixed outer end, a chain configured to connect the plate and the unfixed outer end of the spring such that the plate can be manually removed against spring urgency and the plate can return to the housing under the spring urgency, wherein the operative position of the plate holds the plate; and
a mounting element configured to attach the housing to the motorcycle.

2. The accessory of claim 1, wherein the housing in a non-operative position holds the plate such that the spring urgency prevents any rattling of the chain against the motorcycle.

3. The accessory of claim 1, wherein the mounting element is non-removably attached to the motorcycle via a pipe on the motorcycle.

4. The accessory of claim 1, wherein the mounting element is removably attached to the motorcycle via a rod on the motorcycle.

5. The accessory of claim 1, wherein the plate further comprises a flange on an extremity facing away from the spring.

6. The accessory of claim 5, wherein the flange further comprises a ring element secured to the flange by an attachment means.

7. The accessory of claim 1, wherein the plate is removably attached to the chain such that the plate can be replaced by a different plate.

8. The accessory of claim 1, wherein the slip-mitigating surface is a spiked surface, an abrasive surface, or a ridged surface.

9. An accessory attachable to a motorcycle for alleviating a weight of a motorcycle from bearing down on a kickstand, the accessory comprising:
a plate having an operative position interposed between a leg and a surface;
a housing configured to store the plate, a spring having an inner end fixed against movement and presenting an unfixed outer end, a chain configured to connect the plate and the unfixed outer end of the spring such that the plate can be manually removed against spring urgency and the plate can return to the housing under the spring urgency, wherein the operative position of the plate holds the plate;
a mounting element configured to attach the housing to the motorcycle;
a light; and
a power source configured to power the light.

10. The accessory of claim 9, further comprising a computing circuitry including a processor, a memory and a transceiver, wherein, the computing circuitry is configured to transmit GPS coordinates of the computing circuitry to an application and receive an instruction to turn on the light.

11. The accessory of claim 9, wherein the light is configured to turn on only when the plate is pulling from the housing.

12. The accessory of claim 11, wherein:
the housing further comprises a first magnetic element;
the plate further comprises a flange;
the flange further comprises second magnetic element; and
the second magnetic element is configured to mate with the first magnetic element such that the plate is removably secured to the housing.

13. The accessory of claim 9, wherein the plate further comprises a flange, wherein the flange comprises a pull element.

14. The accessory of claim 9, wherein the plate further comprises a flange, wherein the flange comprises:
a lock configured to engage with a key; and
an operable element, wherein the operable element is operably attached to the lock such that an engagement of the lock with the key moves the operable element either into a locked position or an unlocked position.

15. The accessory of claim 14, wherein the housing further comprises a lip configured to meet the operable element in the locked position.

16. An accessory for a motorcycle for alleviating a weight of a motorcycle from bearing down on a kickstand, the accessory comprising:
a plate having an operative position interposed between a leg and a surface;
a housing configured to store the plate, a spring having an inner end fixed against movement and presenting an unfixed outer end, a chain configured to connect the plate and the unfixed outer end of the spring such that the plate can be manually removed against spring urgency and the plate can return to the housing under the spring urgency, wherein the operative position of the plate holds the plate;
a mounting element configured to attach the housing to the motorcycle; and
a heat sensitive element.

17. The accessory of claim 16, wherein the heat sensitive element covers part or whole of the surface of the plate.

18. The accessory of claim 17, wherein the heat sensitive element is configured to perform a visual change in reaction to a change in temperature.

19. The accessory of claim 18, wherein the visual change is a change from a first color to a second color, a change from a first pattern to a second pattern, or a change from no pattern to a first pattern.

20. The accessory of claim 18, wherein the heat sensitive element is configured to perform the visual change in reaction to a change in temperature from below 100 degrees Fahrenheit to at or above 100 degrees Fahrenheit.
